(19) United States
(12) Patent Application Publication
(10) Pub. No.: US 2026/0031674 A1
(43) Pub. Date: Jan. 29, 2026

(54) Replacing a Bearing in an Electrical Machine, in Particular an Electric Motor

(71) Applicant: Zollern GmbH & Co. KG, Sigmaringendorf (DE)

(72) Inventor: Peter Berger, Herbertingen (DE)

(73) Assignee: Zollern GmbH & Co. KG, Sigmaringendorf (DE)

(21) Appl. No.: 19/280,965

(22) Filed: Jul. 25, 2025

(30) Foreign Application Priority Data
Jul. 26, 2024 (DE) 102024121414.7

(51) Int. Cl. H02K 5/173; H02K 1/24

(52) U.S. Cl. CPC H02K 5/173; H02K 1/24

(57) ABSTRACT

An electrical machine (1), comprising: a housing (10) and a stator (14); and a rotor (20) having a rotor shaft (21) which is mounted on the housing (10), such that it can rotate about a rotational axis (D), via rotary bearings (31, 41), wherein at least one of the rotary bearings (31; 41) is releasably fastened to the housing (10) and can be removed from the housing (10) and the rotor shaft (21) by a movement along the rotational axis (D). The electrical machine (1) also comprises a holding device (5; 5′) which prevents the rotor (20) from coming into contact with the stator (14) when the rotary bearing (31; 41) is or is being removed from the housing (10).

### FIELD OF THE INVENTION

The invention relates to an electrical machine, in particular an electric motor, in which a rotary bearing, via which a rotor shaft is rotatably mounted on a housing of the machine, can be replaced. The electric motor is preferably a so-called torque motor. The invention also relates to a method for replacing a rotary bearing of such an electrical machine.

### BACKGROUND OF THE INVENTION

Torque motors exhibit very high torques at relatively low rotational speeds. They are often used as a direct drive, i.e. with no intermediate gear system.

Torque motors in particular have a long service life. It can nonetheless occur that one or more bearings which rotatably mount a rotor shaft, in particular on a housing of the electrical machine, need to be replaced.

### SUMMARY OF THE INVENTION

An aspect of the invention is based on describing an electrical machine in which a bearing can be replaced in a simple way. Another aspect is a method for replacing a bearing in an electrical machine.

An aspect of the invention is based on an electrical machine, such as for example an electric motor, which can for example be embodied as a torque motor. The electrical machine comprises a housing and a stator which is fixed in relation to the housing or fastened to the housing. The electrical machine also comprises a rotor having a rotor shaft which is mounted on the housing, such that it can rotate about a rotational axis, via at least one rotary bearing, such as for example a first rotary bearing and a second rotary bearing. The stator can comprise a plurality of windings or coils made of an electrical conductor, wherein electrical current flowing through the windings or coils generates a rotating magnetic field which induces a rotational movement of the rotor. The stator can also comprise one or more electrical sheets, made for example of an iron material. The rotor can for example comprise a multitude of permanent magnets which are induced to rotate about the rotational axis by the rotating magnetic field of the stator, wherein they entrain the rotor accordingly.

A circumferential air gap which is formed between the rotor, in particular the permanent magnets, and the stator exhibits a gap width which is as small as possible but nonetheless large enough that the rotor and the stator do not contact each other.

The rotary bearing or bearings via which the rotor shaft is rotatably supported on the housing ensure(s) that the rotor and stator do not contact each other and/or that the air gap is maintained. However, if the rotary bearing or one of the rotary bearings is replaced, the supporting function is lost on at least one side of the rotor shaft, which could tilt the rotor shaft in relation to the rotational axis and attract the permanent magnets to the stator or the electrical sheet of the stator, which could damage the stator and/or rotor. The large magnetic forces also make it difficult to release a rotor resting against the stator from the stator without causing damage.

The electrical machine is embodied such that the rotary bearing or at least one of the rotary bearings can be replaced, in particular without having to dismantle the entire electrical machine. This has the advantage that the electrical machine can be repaired in the field, i.e. in situ, using one or more replacement rotary bearings. This enables downtimes of a machine in which the electrical machine is installed to be minimized. The rotary bearing or at least one or both of the rotary bearings can be releasably fastened to the housing and removed or withdrawn from the housing and for example also the rotor shaft by a movement along the rotational axis. The rotary bearing or bearings can (each) be arranged on an end-facing wall of the housing, via which the rotor shaft is supported on the housing or on the end-facing wall of the housing.

The electrical machine comprises a holding device which prevents the rotor from coming into contact with the stator when the rotary bearing is or is being removed from the housing. The holding device enables the rotary bearing to be removed or replaced, wherein the holding device performs the radial supporting function of the rotary bearing, in particular until the rotary bearing is replaced with a new rotary bearing. Because the holding device prevents the rotor or rotor shaft from tilting in relation to the rotational axis when the rotary bearing is or is being removed from the housing, the disadvantages associated with the rotor contacting the stator can be avoided.

The holding device or a part of the holding device can be removed from the electrical machine when the rotor is mounted on the housing, such that it can rotate about the rotational axis, via the rotary bearings. Another part of the holding device can be attached to the electrical machine, for example to the housing of the electrical machine, for the duration of this or permanently.

The holding device or a part of the holding device can for example be attached to the electrical machine when or only when the rotary bearing or one of the rotary bearings is to be removed from the housing or replaced.

The holding device can comprise at least one holding body which can be moved from a position in which it is out of engagement with the rotor, into an engaging position in which it is in engagement with the rotor in such a way that it prevents the rotor shaft from tilting in relation to the rotational axis. This prevents the rotor from coming into contact with the stator when the rotary bearing is or is being removed from the housing. The holding body can for example be removed from the electrical machine in a position in which it is out of engagement with the rotor, or it can be permanently attached to the electrical machine. If the at least one holding body is removed from the electrical machine, it is attached to the electrical machine as required, i.e. when the rotary bearing is to be removed from the housing. The rotor can be supported on the housing, in particular on an end-facing wall of the housing, via the at least one holding body, whereby it performs the radial supporting function of the rotary bearing, for example while the bearing is replaced, and prevents the rotor shaft from tilting in relation to the rotational axis.

In general, when one of the rotary bearings is removed, the rotor can be supported on the housing via the other rotary bearing on the one hand and the holding device, in particular the at least one holding body, on the other. The end-facing wall can for example comprise one or more openings via which the at least one holding body or a plurality of holding bodies can be inserted, for example plugged or screwed, into the housing in order to be moved into the engaging position with the rotor. When the at least one holding body is not attached to the electrical machine, the at least one opening can be covered by means of a cover such as for example a screw or cap.

A plurality of holding bodies can for example be arranged in a distribution over the circumference of the rotor. In order to prevent the rotor from tilting as reliably as possible, at least three holding bodies can for example be arranged in a distribution over the circumference of the rotor. This can be advantageous in particular when the at least one holding body is embodied in the shape of a bolt or is a screw bolt. The aforesaid openings can be provided at least in accordance with the number of holding bodies.

The at least one holding body can be inserted into the housing from an end-facing side of the housing, for example an end-facing wall which forms the end-facing side of the housing, for example via the at least one opening mentioned, in order to move it into the engaging position. The rotor can comprise a holding surface, which is for example embodied as a centering surface and which rests against or is supported on the at least one holding body when the at least one holding body is in the engaging position. The holding surface can for example be an inner circumferential surface of the rotor. The inner circumferential surface can for example rest against or be supported on an outer circumference or an engaging portion of the at least one holding body.

The end-facing wall which forms an end-facing side of the housing can form a guide of the holding device for the holding body or for each of the holding bodies, wherein the holding body is supported on the end-facing wall via said guide, thus for example minimizing or preventing the elongated holding body from tilting in relation to the introducing direction. This ensures that the rotor or rotor shaft is at least prevented from tilting in relation to the rotational axis enough that the rotor comes into contact with the stator when the rotary bearing is or is being removed from the housing.

At least one guide body of the holding device, which guides the holding body, for each holding body can be arranged on the inner side of the end-facing wall of the housing which forms an end-facing side. This can even more effectively prevent the holding body and therefore the rotor or rotor shaft from tilting. The end-facing wall can simultaneously be thinner. The at least one guide body can be embodied as a bushing. The guide body, which is for example shaped as a bushing, can be welded or otherwise fastened to the inner side of the end-facing wall.

The at least one guide body can for example comprise an inner thread into which an outer thread of the holding body is screwed. The holding body can be moved or screwed into the engaging position by rotating it in a first rotational direction and can be moved or screwed out of the engaging position by rotating it in a second rotational direction which is opposite to the first rotational direction. The engaging portion can for example comprise the thread. The holding surface can for example be supported on the thread of the engaging portion. An end of the holding body which is arranged outside the electrical machine can for example comprise an entraining profile, such as for example an outer hexagonal profile or an inner hexagonal profile, in order to be able to screw the holding body into or out of the engaging position using a corresponding tool.

Alternatively or additionally, the holding body can comprise a cylindrical guide shaft which is guided by a cylindrical inner circumferential wall of the at least one guide body. A corresponding fit, for example a clearance fit, between the cylindrical outer circumference of the guide shaft and the cylindrical inner circumference of the at least one guide body can prevent or at least minimize the holding body tilting.

A first guide body which is for example embodied as a bushing, and a second guide body which is for example embodied as a bushing, can for example be provided for each holding body. The first guide body can for example comprise the inner thread and the cylindrical inner circumferential surface for the guide shaft. In alternative embodiments, the first guide body can be embodied without an inner thread.

The first guide body is preferably arranged, for example welded, on the end-facing surface of the end-facing wall of the housing which points towards the interior space or rotor. The second guide body can for example be a bushing which is inserted, in particular press-fitted, into the end-facing wall and which likewise comprises an inner circumferential surface which is adapted to the cylindrical outer circumference of the guide shaft. The inner circumferential surface can for example co-operate with the cylindrical outer circumferential surface of the guide shaft by means of a clearance fit. The embodiment comprising a first and second guide body enables the holding body to be even more broadly supported and even more effectively prevented from tilting.

In embodiments of the holding body with no thread, i.e. comprising for example a guide shaft only, the holding body can be shifted in its longitudinal direction into and out of the engaging position. In embodiments of the holding body comprising a thread, the holding body can be screwed in its longitudinal direction into and out of the engaging position. In embodiments of the holding body comprising a thread and a cylindrical guide shaft, the holding body can be screwed into and out of the engaging position, wherein the cylindrical guide shaft compensates for a relatively large clearance in the threaded engagement and prevents the holding body from tilting particularly well. In embodiments of the holding body comprising a thread and a guide shaft, the guide shaft can for example be arranged between the engaging portion, which is provided with the thread and simultaneously forms one end of the holding body, and the entraining profile which for example forms the other end of the holding body.

The rotary bearing which the holding device mentioned here is intended to compensate for while it is removed or replaced can be part of a bearing unit which is likewise removed from the housing and/or rotor shaft when replacing or removing the rotary bearing. The bearing unit, which can comprise the rotary bearing and a bearing seating body which surrounds the rotary bearing on its outer circumference, can be releasably fastened to the housing, in particular to the end-facing wall of the housing, and can be capable of being removed from the housing wall. The bearing seating body can be fastened to the housing or to the end-facing wall of the housing by means of at least one releasable fastening element, such as for example one or more screw bolts. The bearing seating body can for example comprise an outer circumferential surface which: matches an inner circumferential surface of the housing, in particular the end-facing wall of the housing, which is embodied as a centering surface; and centers the bearing seating body and the rotary bearing in relation to the rotational axis when the bearing unit is arranged on or fastened to the housing, in particular the end-facing wall of the housing. The bearing seating body can be removed or withdrawn as a unit together with the rotary bearing from the housing and/or rotor shaft by a movement along the rotational axis of the rotor shaft.

The rotary bearing can for example be a slide bearing or a roll bearing. A rotary bearing which is embodied as a roll bearing can comprise an inner ring, which is arranged on a bearing seating surface of the rotor shaft, and an outer ring which is arranged on an inner circumferential surface of the bearing seating body. Rolling bodies such as for example rollers or spheres are situated between the inner ring and the outer ring. The rotary bearing, in particular the outer ring of the rotary bearing, can be axially fastened along the rotational axis of the rotary bearing in relation to the bearing seating body, for example by means of at least one bearing holding body such as for example a first bearing holding body and a second bearing holding body which are formed by or fastened to the bearing seating body. A seating for a shaft gasket, in particular a radial shaft sealing ring, can be formed on the first bearing holding body and/or the second bearing holding body. The at least one shaft gasket can rest against a sealing surface of the rotor shaft in a seal, wherein the sealing surface can rotate together with the rotor shaft about the rotational axis in relation to the shaft gasket. The at least one shaft gasket seals the rotary bearing off from the interior space in which the rotor is arranged and/or from the outer side of the electrical machine. A first shaft gasket, which is seated on the first bearing holding body, and a second shaft gasket which is seated on the second bearing holding body can for example be provided, wherein the rotary bearing is arranged between the first shaft gasket and the second shaft gasket.

The rotary bearing can thus be sealed off from both the interior space and the outer side. A lubricant supply, such as for example a lubricating nipple, can for example be provided via which lubricant, such as for example lubricating grease, can be supplied to the rotary bearing, wherein the two shaft gaskets prevent the lubricant from escaping to the interior space and the outer side.

The inner ring of the rotary bearing can for example be secured against shifting along the rotational axis in relation to the rotor shaft by means of an axial securing element which is fastened to the rotor shaft. The axial securing element can for example be embodied as a shaft securing ring. The axial securing element can be removed before the bearing unit or rotary bearing is removed. The axial secured rotor or rotor shaft is held in a desired position along the rotational axis in relation to the stator or housing.

In developments, the rotor can comprise permanent magnets which are embodied in the shape of rods exhibiting a longitudinal direction. A plurality of permanent magnets can be arranged in a row in the longitudinal direction of the rods, to form a row along the rotational axis. A plurality of such rows can be arranged with alternating polarity in the circumferential direction of the rotor. While one row exhibits a north-south polarity in the circumferential direction, the adjacent rows each exhibit a south-north polarity, etc. The rotor can comprise a magnet carrier on which the permanent magnets are seated and form an outer circumference of the rotor. The aforementioned air gap is formed between the outer circumference or outer circumferential surfaces of the permanent magnets and the stator.

The electrical machine described here can for example be embodied as a motor or torque motor. Because the rotary bearing can be replaced in the field or in situ, the electrical machine is suitable wherever downtimes are to be minimized. The electrical machine mentioned here can be particularly advantageously used as a drive for a pellet press or pelleting plant, such as for example for producing wood pellets or feed pellets. It is often desired for pelleting plants to operate around the clock. Since high torques and low rotational speeds are advantageous in pelleting plants, the motor can ideally be embodied as a torque motor. Such motors have a corresponding size, hence replacing a bearing in the field, with only a short downtime, is desired.

An aspect of the invention also relates to a method for replacing a rotary bearing in an electrical machine, in particular an electrical machine as described here. Before the rotary bearing is removed, at least one and for example more than one holding body of a holding device is moved into an engaging position. In the engaging position, the at least one holding body is in engagement with the rotor of the electrical machine in such a way that a rotor shaft is prevented from tilting in relation to a rotational axis of the rotor or rotor shaft. This prevents the rotor from coming into contact with the stator while the bearing is replaced or removed. Once the at least one holding body has been moved into the engaging position with the rotor, the rotary bearing via which the rotor shaft is mounted on the housing of the electrical machine, in particular on an end-facing wall of the housing, is removed or withdrawn from the housing, for example the end-facing wall, and from the rotor shaft along the rotational axis. As already shown, the at least one holding body which is situated in the engaging position prevents the rotor from coming into contact with the stator when the rotary bearing is removed or is being removed from the housing.

Once the rotary bearing has been removed, for example together with the optional bearing unit in which the rotary bearing is arranged, another rotary bearing which is for example an identically designed rotary bearing can be fitted onto the rotor shaft along the rotational axis and assembled on the housing. The rotary bearing can for example be inserted into the bearing unit of the previously removed rotary bearing and fitted onto the rotor shaft and assembled on the housing together with the bearing unit. Alternatively, a new bearing unit including a rotary bearing can also be used. The bearing unit or the rotary bearing is fastened to the housing, in particular the end-facing wall and/or the rotor shaft. The rotor shaft can then be supported in the radial direction on the housing, in particular the end-facing wall, via the new rotary bearing and the optional bearing unit. Once the rotary bearing has been assembled onto the rotor shaft and housing, the at least one holding body can be moved out of the engaging position and optionally removed from the electrical machine.

The at least one holding body can for example be a screw bolt which is moved into the engaging position by being rotated in a first rotational direction and is moved out of the engaging position by being rotated in a second rotational direction which is opposite to the first rotational direction.

The method can be developed from the processes described in relation to the device.

### BRIEF DESCRIPTION OF THE DRAWINGS

An aspect of the invention has been described on the basis of a number of examples and embodiments. An embodiment is described below on the basis of figures. The features thus disclosed, individually and in any combination of features, advantageously develop the subject matter of the claims without restricting the claims in the process. In the figures:

FIG. 1 shows a cross-sectional view of an electrical machine along a rotational axis;

FIG. 2 shows a detail of the view from FIG. 1, wherein a rotary bearing is being removed;

FIG. 3 shows a cross-sectional view of the electrical machine, perpendicular to the rotational axis; and

FIG. 4 shows a perspective view of an electrical machine.

### DETAILED DESCRIPTION OF EXEMPLARY EMBODIMENTS

The electrical machine shown in the figures is embodied as a torque motor and allows a first rotary bearing 31 and a second rotary bearing 41 to be replaced while preventing a rotor 20 from coming into contact with a stator 14 when one of the rotary bearings 31, 41 is or is being removed from a housing 10.

The electrical machine 1 comprises a housing 10 which surrounds an interior space in which a rotor 20 is arranged such that it can be rotated about a rotational axis D. The housing 10 comprises a circumferential wall 13 which surrounds the rotor 20 around the rotational axis D and on the inner side of which a stator 14 is arranged which comprises a plurality of windings 14a which, when an electrical current flows through them, can generate a magnetic field which rotates about the rotational axis D. The outer side of the circumferential wall 13 comprises a plurality of cooling channels which extend in the circumferential direction and are covered by an annular cover which extends over the circumference around the rotational axis D.

The two end-facing sides of the housing 10 are formed by a first end-facing wall 11 and a second end-facing wall 12 which laterally enclose the interior space and between which the circumferential wall 13 comprising the stator 14 is arranged. In the example shown, the first and second end-facing walls 11, 12 form fastening flanges 15 (FIG. 4) which serve as feet and for fastening for example to a foundation of a machine, such as for example a pelleting plant. Due to the large mass of the electrical machine, it can comprise drilled lugs 16, which are for example formed on the end-facing walls 11, 12, for attaching a hoist.

The electrical machine 1 comprises an electrical junction box 3 in which the windings 14a can be connected to a voltage supply. Connecting lines lead from the junction box 3 to the windings 14a between the first end-facing wall 11 and the windings 14a. The distance between the windings 14a and the first end-facing wall 11 is therefore greater than the distance between the windings 14a and the second end-facing wall 12.

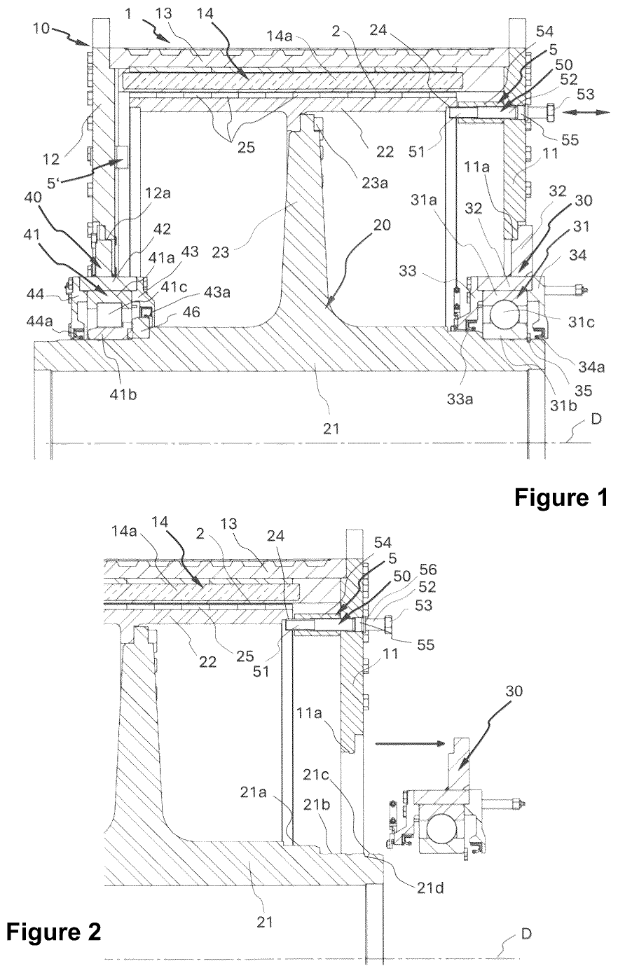

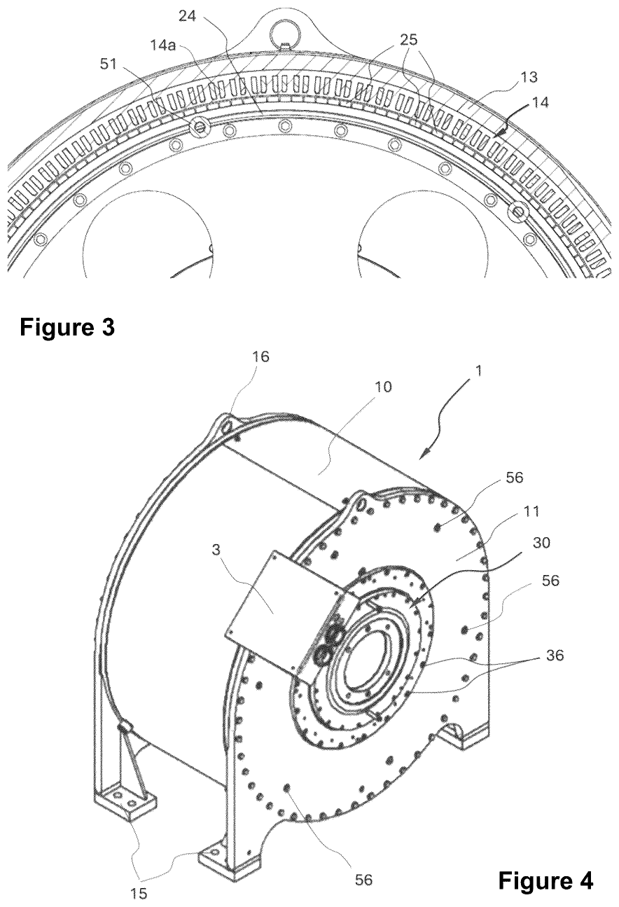

The rotor 20 comprises a rotor shaft 21 which in this example is embodied as a hollow shaft and which is mounted and supported on the first end-facing wall 11 and the second end-facing wall 12, such that it can be rotated about the rotational axis D, via the first rotary bearing 31 and the second rotary bearing 41. The rotor 20 comprises an annular magnet carrier 22 which surrounds the rotor shaft 21 and is non-rotationally connected to the rotor shaft 21 via a connecting stay 23 which protrudes radially from the rotor shaft 21. The connecting stay 23 is fastened to the magnet carrier 22 by means of screw bolts 23a. The outer circumference of the magnet carrier 22 comprises a multitude of permanent magnets 25 which in the example shown are elongated and extend in their longitudinal direction parallel to the rotational axis D. The elongated or rod-shaped permanent magnets 25 are arranged in a row in the longitudinal direction of the rods, to form a row (see for example FIG. 1). The polarity of the permanent magnets 25 extends in the circumferential direction or transversely to the longitudinal direction of the rods of the permanent magnets. The magnets within a row have the same polarity. A plurality of such rows are arranged over the circumference of the rotor 20 (see FIG. 3), wherein these rows have alternating polarities.

The permanent magnets 25 form the outer circumference of the rotor 20. An air gap which is formed between the outer circumference of the rotor 20 or the permanent magnets 25 and the stator 14 which surrounds the rotor 20 over its outer circumference is as small as possible but nonetheless large enough that the stator 14 and the rotor 20, in particular the magnets 25 of the rotor 20, do not contact each other.

The electrical machine 1 comprises a first bearing unit 30, comprising the first rotary bearing 31 via which the rotor shaft 21 is rotatably supported on the first end-facing wall 11, and a second bearing unit 40 comprising the second rotary bearing 41 via which the rotor shaft 21 is rotatably supported on the second end-facing wall 12. The first rotary bearing 31 and the second rotary bearing 41 are embodied as roll bearings. The first rotary bearing 31 is a ball bearing, wherein the second rotary bearing 41 is a roller bearing. The rotary bearings 31, 41 comprise an inner ring 31b, 41b which is seated on a bearing seating surface 21b (shown in FIG. 2 for the first rotary bearing 31) on the rotor shaft 21. The first rotary bearing 31 is embodied as a fixed bearing, wherein the inner ring 31b is enclosed between a step of the rotor shaft 21 and an axial securing element 35 arranged in an annular groove of the rotor shaft 21. The second rotary bearing 41 can be formed as a floating bearing.

The first and second rotary bearings 31, 41 comprise an outer ring 31a, 41a, the outer circumference of which is seated on an inner circumference of a bearing seating body 32, 42 of the first bearing unit 30 or second bearing unit 40. The rotary bearings 31, 32 comprise a rolling body 31c, 41c between the outer ring 31a, 41a and the inner ring 31b, 41b. The rolling body 31c of the first rotary bearing 31 is embodied as a sphere. The rolling body 41c of the second rotary bearing 41 is embodied as a roller.

As can most clearly be seen from FIG. 1, the bearing units 30, 40 comprise a first bearing holding body 33, 43 towards the interior space and a second bearing holding body 34, 44 towards the outer side. The outer ring 31a, 41a is enclosed or clamped between the first bearing holding body 33, 43 and the second bearing holding body 34, 44 along the rotational axis D. The bearing holding bodies 33, 34, 43, 44 are formed on or fastened to the bearing seating body 32, 42 of the first bearing unit 30 or second bearing unit 40, for example by means of screw bolts (FIGS. 1 and 4). The first end-facing wall 11 comprises a centering surface 11a which is formed as an inner circumferential surface. The second end-facing wall 12 comprises a centering surface 12a which is formed as an inner circumferential surface. The first bearing seating body 32 comprises an outer circumferential surface which rests against the centering surface 11a and centers the first bearing unit 30 in relation to the rotational axis D. Similarly, the second bearing seating body 42 also comprises an outer circumferential surface which rests against the centering surface 12a and centers the second bearing unit 40 in relation to the rotational axis D. The first bearing unit 30 and the second bearing unit 40 are releasably fastened to the first end-facing wall 11 and the second end-facing wall 12 via fastening elements 36 which are for example embodied as screw bolts.

The first bearing holding body 33, 43 holds a first shaft gasket 33a, 43a. The shaft gasket 33a, 43a forms a sealing gap with a sealing surface of the rotor shaft 21. The shaft sealing ring 43a forms a sealing gap with a sealing surface of a spacer ring 46. The spacer ring 46 is arranged between a step of the rotor shaft 21 and the inner ring of the rotary bearing 41 and can rotate about the rotational axis D together with the rotor shaft 21. The second bearing holding body 34, 44 holds a second shaft sealing ring 34a, 44a which forms a sealing gap together with a sealing surface 21c (the first rotary bearing is shown in FIG. 2). The first rotary bearing 31 is arranged between the first shaft gasket 33a and the second shaft gasket 34a of the first bearing unit 30. The second rotary bearing 41 is arranged between the first shaft gasket 43a and the second shaft gasket 44a of the second bearing unit 40. This enables lubricant to be held on the respective rotary bearing 31, 41. Optionally, a lubricating nipple can be provided, via which the respective rotary bearings 31, 41 can be supplied with lubricant (see FIG. 1).

The electrical machine 1 comprises a holding device 5 which prevents the rotor 20, in particular the permanent magnets 25, from coming into contact with the stator 14 when the rotary bearing 31 is or is being removed from the housing 10. Optionally, such a holding device 5′ can also be provided for replacing the other rotary bearing 41 (FIG. 1). The holding device 5′ can be constructed in the same way as the holding device 5, except that it is arranged on the second end-facing wall 12 and is somewhat shorter.

The holding device 5 (and optionally 5′) comprises at least one holding body 50 which can be moved into an engaging position in which it is in engagement with the rotor 20 in such a way that it prevents the rotor shaft 21 from tilting in relation to the rotational axis D. The holding device 5 comprises a holding body 50 which in the example shown is embodied as a screw bolt and comprises an engaging portion 51 at one end and, at its other end, an entraining profile 53 which in the example shown is embodied as an outer hexagon. A guide shaft 52 which the holding body 50 comprises between the engaging portion 51 and the entraining profile 53 comprises a cylindrical outer surface which co-operates with a cylindrical inner surface of a first guide body 54 and second guide body 55 which are each embodied as a bushing. The engaging portion 51 comprises an outer thread which engages an inner thread of the first guide body 54. The holding body 50 is moved or screwed into an engaging position by rotating it in a first rotational direction and is moved or screwed out of the engaging position (see the double-headed arrow in FIG. 1) by rotating it in the second rotational direction. Since the threaded engagement can exhibit a relatively large radial clearance, which can lead to the holding body 50 tilting in relation to its longitudinal direction and therefore to the rotor 20 tilting in relation to the rotational axis D, the guide shaft 52 is guided narrowly, such as for example by means of a clearance fit, on the inner circumference of the first guide body 54 and on the inner circumference of the second guide body 55.

The first guide body 54 is fastened, such as for example welded, to the inner side of the first end-facing wall 11 (or second end-facing wall 12), i.e. the side pointing towards the rotor 20. The second guide body 55 is for example embodied as a bushing and press-fitted into a drilled hole in the first end-facing wall 11 (or second end-facing wall 12). Alternatively, in embodiments with no second guide body 55, the first end-facing wall 11 can perform the function of the second guide body 55, namely that of guiding the guide shaft 52, wherein for this purpose, the end-facing wall 11 comprises a drilled hole having an inner circumference on which the guide shaft 52 is guided.

The rotor 20, for example the magnet carrier 22, comprises a holding surface 24 which serves as a centering surface. The holding surface 24 is an inner circumferential surface in the example shown, but can also be an outer circumferential surface or a groove. In the engaging position of the holding body 50 shown in FIG. 1, the holding body 50 (for example, the engaging portion 51) is in engagement with the holding surface 24. The holding surface 24 can rest against the engaging portion 51, thus preventing the rotor shaft 21 from tilting in relation to the rotational axis D in at least one direction. In the example shown, a plurality of holding devices 5 (such as for example at least three) are provided in a distribution over the circumference, the openings 56 of which (into each of which a holding body 50 can be inserted) are shown in FIG. 4.

Before the first rotary bearing 31 is removed, in order for example to be replaced, a plurality of holding bodies 50 are inserted into the housing 10 from the end-facing wall 11 via the openings 56 and screwed into the engaging position by being rotated in a first rotational direction. The releasable fastening elements using which the first bearing unit 30 is fastened to the first end-facing wall 11 are then released. If, as shown in FIG. 1, an axial securing element 35 is optionally provided, it is likewise removed. The bearing unit 30, together with the first rotary bearing 31, is then withdrawn from the first end-facing wall 11 and rotor shaft 21 along the rotational axis D. The holding bodies 50 which are situated in their engaging positions prevent the rotor shaft 21 from tilting in relation to the rotational axis D, such that the rotor 20 is also prevented from coming into contact with the stator 14, since the supporting function of the first rotary bearing 31 has now been lost. The other rotary bearing, such as for example the rotary bearing 41, remains installed for the duration of this. Optionally, it can be replaced once the first rotary bearing 31 has been replaced, using the same method as for the first rotary bearing 31, but by means of the holding device 5′.

Alternatively, holding bodies 50 can be moved into an engaging position with the holding surface of the magnet carrier 22, shown on the left-hand side in FIG. 1, from the other side via the holding device 5′. This would enable the first bearing unit 30 and the second bearing unit 40 to be removed simultaneously.

Once the first rotary bearing 31 has been replaced, it can be assembled onto the rotor shaft 21 together with the bearing unit 30 along the rotational axis D and fastened to the housing 10. The at least one holding body 50 can then be moved out of the engaging position and, in the example shown, removed from the electrical machine 1. The same method is followed for the second rotary bearing 41. The openings 56 can be closed off by means of suitable covers, in order to prevent foreign bodies from entering the interior space of the electrical machine 1.

List of reference signs

| | |
|---|---|
| 1 | electrical machine/electric motor |
| 2 | air gap |
| 3 | junction box |
| 5 | holding device |
| 5′ | holding device |
| 10 | housing |
| 11 | first end-facing wall |
| 11a | centering surface |
| 12 | second end-facing wall |
| 12a | centering surface |
| 13 | circumferential wall |
| 14 | stator |
| 14a | windings |
| 15 | fastening flange |
| 16 | drilled lug |
| 20 | rotor |
| 21 | rotor shaft |
| 21a | sealing surface |
| 21b | bearing seating surface |
| 21c | sealing surface |
| 21d | annular groove |
| 22 | magnet carrier |
| 23 | connecting stay |
| 23a | screw bolt |
| 24 | holding/centering surface |
| 25 | permanent magnets |
| 30 | first bearing unit |
| 31 | rotary bearing |
| 31a | outer ring |
| 31b | inner ring |
| 31c | rolling body |
| 32 | bearing seating body |
| 33 | first bearing holding body |
| 33a | first shaft gasket |
| 34 | second bearing holder body |
| 34a | second shaft gasket |
| 35 | axial securing element |
| 36 | fastening element/screw bolt |
| 40 | second bearing unit |
| 41 | rotary bearing |
| 41a | outer ring |
| 41b | inner ring |
| 41c | rolling body |
| 42 | bearing seating body |
| 43 | first bearing holding body |
| 43a | first shaft gasket |
| 44 | second bearing holder body |
| 44a | second shaft gasket |
| 45 | axial securing element |
| 46 | spacer ring |
| 50 | holding body/screw bolt |
| 51 | engaging portion |
| 52 | guide shaft |
| 53 | entraining profile |
| 54 | first guide body/bushing |
| 55 | second guide body/bushing |
| 56 | opening |
| D | rotational axis |

1-12. (canceled)

13. An electrical machine, comprising:
a housing and a stator;
a rotor having a rotor shaft which is mounted on the housing, such that it can rotate about a rotational axis, via rotary bearings,
wherein at least one of the rotary bearings is releasably fastened to the housing and can be removed from the housing and the rotor shaft by a movement along the rotational axis, and
a holding device which prevents the rotor from coming into contact with the stator when the rotary bearing is or is being removed from the housing.

14. The electrical machine according to claim 13, wherein the holding device comprises at least one holding body which is adapted to be moved from a position in which it is out of engagement with the rotor, into an engaging position in which it is in engagement with the rotor in such a way that it prevents the rotor shaft from tilting in relation to the rotational axis.

15. The electrical machine according to claim 14, wherein a plurality of holding bodies are arranged in a distribution over the circumference of the rotor and/or the at least one holding body is shaped as a bolt or a screw bolt.

16. The electrical machine according to claim 14, wherein the at least one holding body is adapted to be inserted into the housing from an end-facing wall which forms an end-facing side of the housing, in order to move it into the engaging position.

17. The electrical machine according to claim 14, wherein at least one guide body for each holding body, which is adapted to guide the holding body, is arranged on the inner side of an end-facing wall of the housing which forms an end-facing side.

18. The electrical machine according to claim 13, further comprising a bearing unit which comprises the rotary bearing and a bearing seating body which surrounds the rotary bearing on its outer circumference, wherein the bearing seating body is fastened to the housing by means of at least one releasable fastening element, and the bearing seating body is adapted to be removed as a unit together with the rotary bearing from the housing by a movement along the rotational axis.

19. The electrical machine according to claim 18, wherein the bearing unit also comprises at least one shaft sealing ring or a radial shaft sealing ring, which rests against the rotor shaft and seals an interior space, in which the rotor is arranged, off from the environment of the electrical machine.

20. The electrical machine according to claim 13, wherein the rotor comprises a multitude of permanent magnets, and the stator comprises a multitude of windings, wherein the permanent magnets are shaped as rods exhibiting a longitudinal direction, and a plurality of permanent magnets are arranged in a row in the longitudinal direction of the rods, to form a row, wherein a plurality of such rows are arranged with alternating polarity in the circumferential direction of the rotor.

21. The electrical machine according to claim 13, wherein the electrical machine is a motor or a torque motor.

22. The electrical machine according to claim 21, wherein the motor or torque motor is for use as a drive for a pelleting plant or pellet press.

23. A method for replacing a rotary bearing of an electrical machine according to claim 13, wherein at least one holding body of a holding device is moved into an engaging position in which it is in engagement with a rotor in such a way that it prevents a rotor shaft of the rotor from tilting in relation to a rotational axis, wherein a rotary bearing via which the rotor shaft is mounted on a housing of the electrical machine is then removed from the housing and rotor shaft along the rotational axis.

24. The method according to claim 23, wherein once the rotary bearing has been removed, another rotary bearing is assembled onto the rotor shaft and onto the housing along the rotational axis, wherein the at least one holding body is then moved out of the engaging position.

25. The method according to claim 23, wherein the at least one holding body is a screw bolt which is moved into the engaging position by being rotated in a first rotational direction and is moved out of the engaging position by being rotated in a second rotational direction which is opposite to the first rotational direction.

26. The method according to claim 24, wherein the at least one holding body is a screw bolt which is moved into the engaging position by being rotated in a first rotational direction and is moved out of the engaging position by being rotated in a second rotational direction which is opposite to the first rotational direction.
